(19) United States
(12) Patent Application Publication
(10) Pub. No.: US 2009/0086016 A1
(43) Pub. Date: Apr. 2, 2009

(54) STEREOSCOPIC IMAGE DISPLAY EMPLOYING SOLID STATE LIGHT SOURCES

(76) Inventor: Wei Su, Sunnyvale, CA (US)

Correspondence Address: Wei Su, 1567 Samedra St, Sunnyvale, CA, 94087, US

(21) Appl. No.: 12/239,778

(22) Filed: Sep. 27, 2008

Related U.S. Application Data
(60) Provisional application No. 60/995,463, filed on Sep. 27, 2007.

(51) Int. Cl. H04N 13/04

(52) U.S. Cl. 348/57; 348/E13.001

(57) ABSTRACT

The present disclosure is a novel design of a polarization based stereoscopic display system that efficiently utilizes the optical energy from three primary color solid state light sources of random polarization, combines the three primary colors into a full color beam of a single polarization state to enable passive separation of the two image channels. The high optical energy efficiency is achieved by splitting each primary color light into two orthogonal polarization states. The single polarization state of the combined full color image beam is achieved by employing a spectrally selective light beam combiner or X-cube. By making the optical configuration of sub-module basically identical and sharing a number of optical components among color and image channels, the size and cost is reduced. By compensating the depolarization effect that is introduced by folding mirror(s), the cross talk between the two displayed stereo images is minimized.

### CROSS REFERENCE TO RELATED APPLICATIONS

This application claims the benefit of provisional patent application Ser. No 60/995,463, filed Sep. 27, 2007 by the present inventors.
US patent
US2006/0007538
US2006/0291053

### FIELD OF THE INVENTION

The present invention relates to stereoscopic display and in particular, to the design of a stereoscopic display system employing solid state light sources.

### BACKGROUND OF THE INVENTION

Traditionally, the stereoscopic image display systems are based on two forms of projection technology. i.e. sequential and simultaneous. In both approaches, two images are generated from two micro-display devices and are projected to a special screen, on which one image is made to be seen only by the left eye and the other image by the right eye. The difference between the images yields depth information, and therefore resulting in strong stereoscopic sensation when they are seen by an observer.

In the sequential approach, the two displayed images are alternated between the left and right eyes, but at a rate higher than most human can distinguish so that the images to the left and right eyes appear continuous. The image sequence can be generated by a special polarization modulation device placed in the light path and then observed through a pair of passive polarization filters, as discussed in publication US 2006/0291053A1. Another approach is to use special digital projectors running at twice the video frame rate and the projected images are then observed through a pair of active shutter glasses operating in synchronization with the projectors. However, these sequential approaches suffer from the “motion effect”, in which a slight movement of the target object in horizontal direction usually results in false stereoscopic perception by the observer, leaving the observer with the impression that the object is moving in-and-out of the monitor screen, which also often result in fatigue to the eye.

In the simultaneous approach, the stereo image pairs, which are recorded with synchronized shutters of dual camera system, are projected through two separate optical projectors/channels at the same time, and viewed individually by left and right eye of the observer. Compared with the sequential approach, this approach does not produce the “motion effect” and is therefore more preferred. However, prior art of simultaneous stereoscopic display systems also have their limitations. For example, in most of commercially available stereoscopic displays, one pair of orthogonal optical polarizers, being either linear or circular, are placed in front of each projector of the two channels to encode the left and right images with two orthogonal polarization states. A pair of matching polarizers is worn by the observer to discriminate the two images between the eyes. This approach suffers from a relatively huge loss of light (up to 70%) and a relatively substantial image cross talk between the two images, with the crossed over images appearing as ghost images. In general, there are two types of projectors that are used for stereoscopic displays, namely, DLP (digital light processor) and liquid crystal based such as an LCOS (liquid crystal on silicon). The DLP projector sequentially projects the three primary colors at high speed. But due to the limited duty cycle, it also requires that the light source of the three primary colors running at higher peak power. This is the main limiting factor for the high brightness displays currently utilizing solid light sources, such as LEDs, which is regarded as the most suitable light source for light projection engines.

On other hand, the liquid crystal based projector also faces challenges. The first one is that it requires the output light from light source to be linearly polarized. At the moment, relatively high power solid state light sources such as LEDs (light emitting diodes) are already available in the three primary colors and they offer high efficiency and long working lifetime. Unfortunately, these high power LEDs generally produce non-polarized or randomly polarized light. As a result, half of the light energy will be lost unless means of polarization recycling is employed. Several polarization re-cycling and color combination schemes have been proposed to combine these three primary colors into a white color (US2006/0007538A1). However, those approaches are complicated and/or inefficient because the combined light, after being injected into the projection engine, is divided again into the three primary colors. The second challenge is caused by the use of a special spectral beam combiner, called an X cube, which is used to combine the three primary color images into a full color image. The most common way to use a traditional X cube is to have the green light enter the cube p-polarized and to have the red and blue light enter the cube s-polarized. As the result, images from the majority of liquid crystal projectors on market currently are linearly polarized in vertical direction for the red and blue color, and in horizontal direction for the green color, as shown in FIG. 1. To generate a co-linearly polarized light from three primary color images, a polarizer can be placed in front of projector and with its polarization axes rotated 45 degrees from the horizontal or vertical direction. Unfortunately, this approach will introduce an additional light loss of at least 50% in theory, which can be as high as 80% in reality. To avoid this extra light loss, as shown in FIG. 2, it has been proposed (US2006/0007538A1) that a color selective half wave-plate 206 to be added behind the X-cube 204 and to selectively rotate only polarization direction of the green light by 90 degrees so that the three primary color light beams are co-linearly polarized before the polarization is further cleaned by an s-polarizer 208, to result in an improved performance in image brightness and contrast. However, this solution, when combined with the polarization recycling scheme will make the projection engine even more complicated.

In addition to the optical energy efficiency issue, another major issue is associated with cross talk between the left and right images. For polarization based stereoscopic displays, the leakage of light from one stereo channel to the other always exist. This often is caused by the depolarization effect of any optical component in the light path. For rear projection based stereoscopic displays, the depolarization introduced by the last folding mirror is almost impossible to be removed.

There is a need for a compact stereoscopic display system that will most efficiently use the optical energy from the three primary color sources and meanwhile further minimize the cross talk between the two stereo channels.

### OBJECTS AND SUMMARY OF THE INVENTION

The present invention discloses a novel design of a liquid crystal based stereoscopic display system that can highly efficiently use the optical energy from solid light sources and divide the three primary colors of random polarizations each into two orthogonal polarization states, one for the left channel and the other for the right channel. By using a special X cube, the combined full color image beam has a co-linear polarization. In addition, by sharing a number of optical components between the two stereoscopic channels, and by making the optical configuration for each color light path identical, except for the coatings that are designed for the specific color spectral band, the presently disclosed design is not only more compact but also of lower in system cost. Furthermore, by employing a depolarization compensation scheme in a rear projection stereoscopic display, the cross talk between two stereoscopic channels is substantially reduced.

One object of the invention is to increase the optical energy efficiency of a stereoscopic display system.

Another object of the invention is to reduce the size of a projection engine used in stereoscopic display.

Another object is to lower the cost of the stereoscopic display system by sharing some of the optical components for both the left and the right channels and by making the optical layout of each sub-channel basically the same.

Still another object is to reduce the cross talk between the two stereo channels.

Additional objects, features and advantages of the various aspects of the present invention will become apparent from the following description of its preferred embodiment, which description should be taken in conjunction with the accompanying drawings.

### BRIEF DESCRIPTION OF THE DRAWINGS

FIG. 1 shows the polarization directions of the three primary colors (R, G, B) after a conventional X-cube that can combine the three colors but with the green color (G) polarized in an orthogonal direction as compared to that of the red (R) and blue (B) colors. With a 45 degree oriented linear polarizer (dotted line) placed in the light path further behind the X-cube, only the components of the light which are parallel to the orientation of the dotted line will pass through the polarizer L.

FIG. 2 shows a prior art X-cube related architecture in which a color selective half wave-plate is added behind the X-cube to selectively rotate the polarization direction of only the green light (G) by 90 degrees so that the three color light (R, G, B) are co-linearly polarized before the polarization is further cleaned by an s-polarizer (out-plane-polarization).

FIG. 3 shows a special spectrally selective beam splitter/combiner or X-cube that reflect light beams in red (R) and blue (B) colors and transmits light beam in green color (G) also in s-polarization (out-plane-polarization).

FIG. 4a shows one side view of the stereoscopic projection engine, illustrating how light beams from two random polarization solid light sources, one being red and the other blue, are divided into two orthogonal linear polarizations to create the left and right images for the red and blue colors.

FIG. 4b shows a side view of the stereoscopic projection engine normal to that of FIG. 4a, illustrating how a green light beam from random polarized solid light source is divided into two orthogonal linear polarizations to create the left and right images for the green color.

FIG. 4c shows a top view of the stereoscopic projection engine, in which the three primary color image paths for one of the two stereo image pair are combined by a special spectrally selective X-cube into full color to be projected onto a screen.

FIG. 4d shows the orientation of ordinary (o) and extraordinary (e) axis of the two quarter wave plates with respect to the linear s-polarization direction, that are used to convert the originally co-linear s-polarization of the left and right channels into circular polarizations of opposite directions.

FIG. 4e shows the top view of the optical layout of the three illumination sub-systems utilizing three primary color solid state light sources.

FIG. 5 shows a front projection arrangement, in which the two projection lenses are displaced with a small distance toward the central axis of the screen from the optical axes of the two stereo imaging paths in order to laterally shift and hence superimpose the left and right images from the two sub-engines on the screen.

FIG. 6 shows a rear projection system that uses the presently disclosed stereoscopic projection engine together with two projection lenses, two reflective mirrors arranged to enable polarization depolarization compensation, and a polarization display screen.

FIG. 7 shows another rear projection embodiment with acute angle reflections to reduce the depth of the display unit and meanwhile maintaining the depolarization compensation arrangement.

FIG. 8a shows the top view of a space saving embodiment for illumination of sub-engine, in which all of the solid light sources and the light homogenization devices are located on one side of the engine.

FIG. 8b shows the side view of one of the color channels of the space saving embodiment of FIG. 8a, in which all of the solid light sources and the light homogenization devices are located on one side of the engine.

FIG. 9a shows the red (R) and blue (B) color channel side view of another embodiment of the stereoscopic display system that has the same optical design for light illumination engine but uses transmissive LCD micro-display chips to achieve the same goal of generating the same single polarization.

FIG. 9b shows the green (G) color channel side view of the embodiment of FIG. 9a.

FIG. 9c shows the top view of the embodiment of FIGS. 9a and 9b, illustrating the imaging channels only.

FIG. 10 an alternative special spectrally selective X-cube combiner for both p and s polarizations that can also be used for the present projection engine.

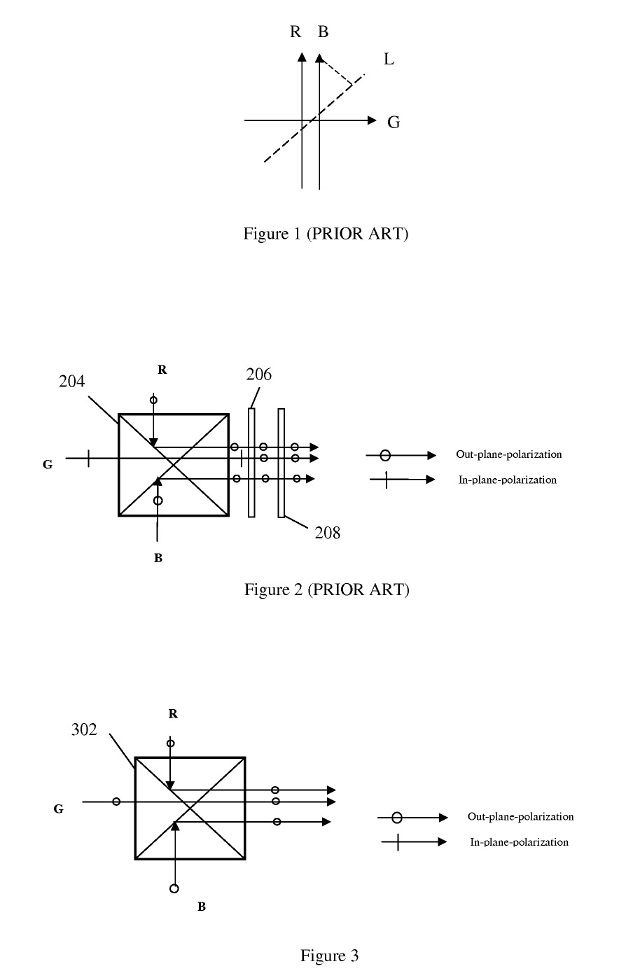

### DETAILED DESCRIPTION OF THE PREFERRED EMBODIMENT

In this invention, a novel digital simultaneously stereoscopic image display is disclosed. The term “simultaneously stereoscopic image display” is referred to the display means in which the stereoscopic image pairs, which are recorded with synchronized shutters simultaneously, is displayed through two optical channels at same time, and viewed individually by left and right eye of the observer. In the present design, the optics of the stereoscopic display can use solid state light source efficiently and also enable the sharing of a number of optical components by both channels. As a result, the optical system is more compact, optically efficient and meanwhile less costly. In addition, the use of solid light sources not only increases the reliability and life time of the light source significantly, but also enlarges the color gamut of display. The solid state light sources discussed in this invention include, but not are limited to, light emitting diode (LED), super luminescent diode (SLD) and laser diode (LD).

As one key feature of the present invention, a specially designed spectrally selective beam splitter/combiner or X-cube is combined with polarization based micro displays, which can be either reflective type LCOSs or transmissive type LCDs for achieving the optical energy efficiency as well as a single polarization for the combined full color image beam. FIG. 3 shows one embodiment of such special spectrally selective beam splitter/combiner or X-cube for combining images formed in three primary colors into a full color image in one polarization direction. The X-cube 302 is special in sense that the light beams in red (R) and blue (B) colors and in s-polarization are reflected by the X-cube 302, while the light beam in green color (G) and also in s-polarization is transmitted through the cube.

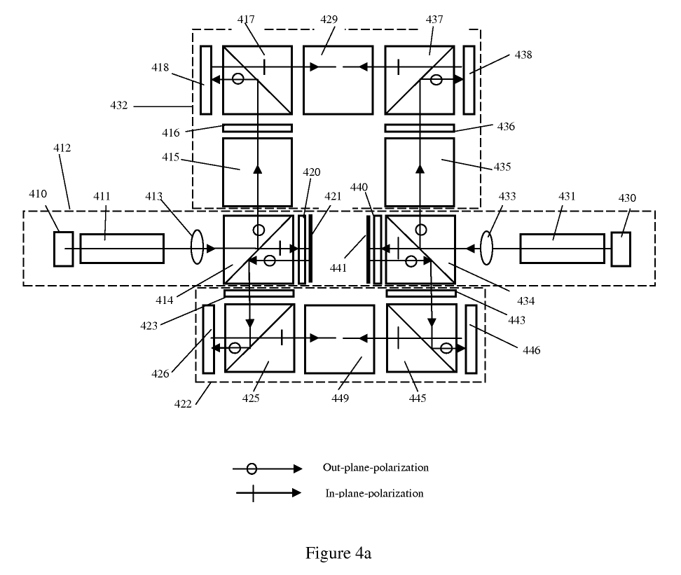

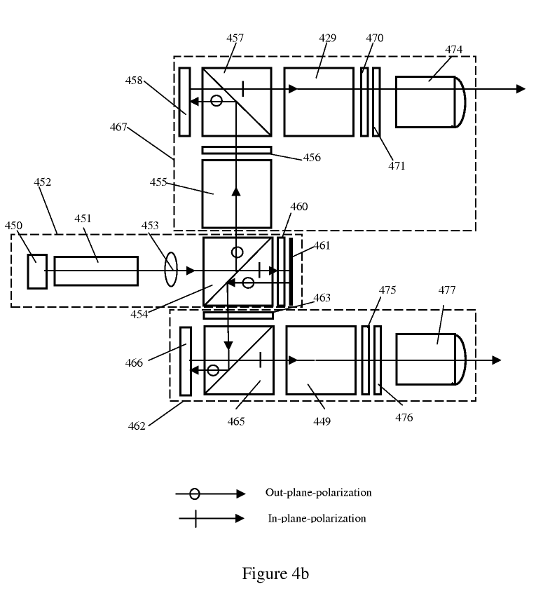

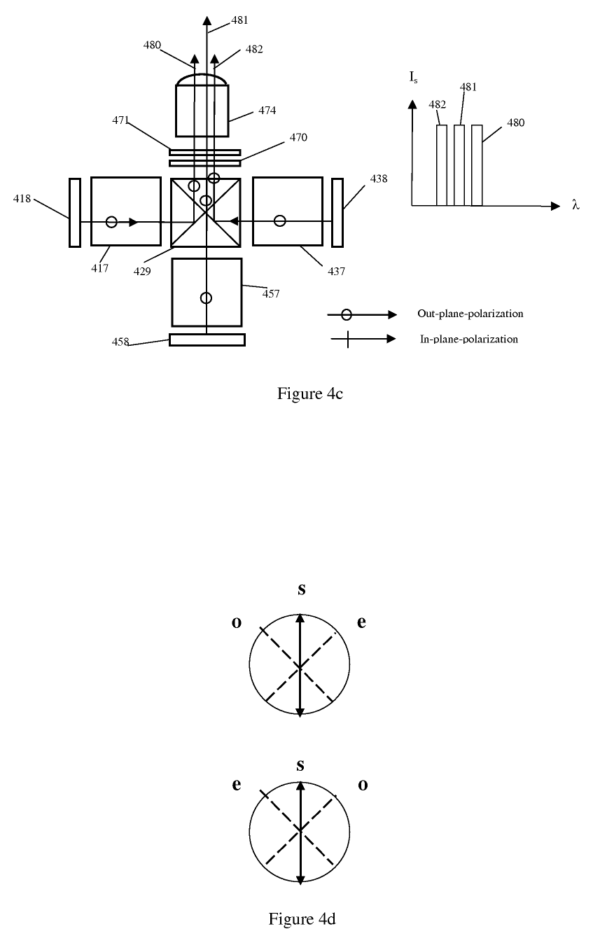

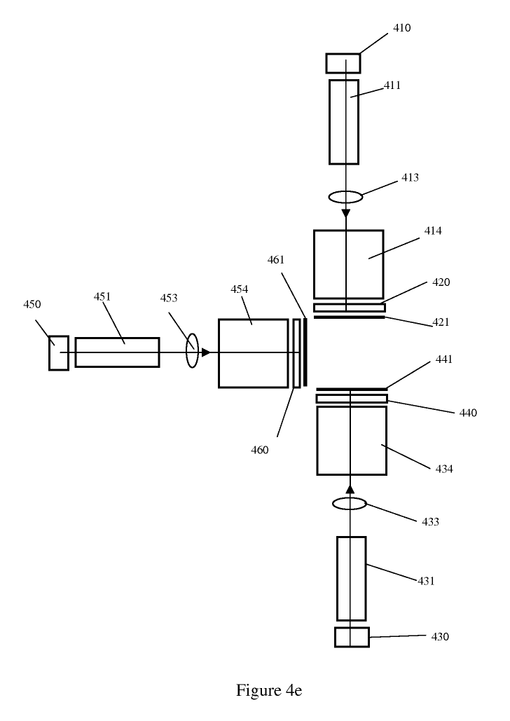

FIGS. 4a, 4b, 4c, 4d, and 4e show one embodiment of the presently disclosed stereoscopic projection engine design as seen in different views. In FIGS. 4a and 4b, an identical optical configuration is used for each of the three primary color channels. By making optics in each of the primary color channels identical, the cost of the projection system can be reduced. The projection engine consists of two sub-modules; one is outlined in blocks 432 and 467 of FIG. 4a and FIG. 4b respectively, and the another in block 422 and 462 of FIG. 4a and FIG. 4b respectively. Of the two sub-modules, one generates a full color image for the left eye and another generates a full color image for the right eye. As will be explained shortly, preferably, solid state light sources 410, 430 and 450 with random polarization light output, non-overlapping and narrow spectral bandwidth, are used to generate the light in three primary colors; and the light from each of the three primary colors is associated with an illumination sub-system and is divided into two orthogonal polarization states to be used for the left and right channels respectively. The illumination sub-system is outlined in block 412 and 452 in FIG. 4a and FIG. 4b respectively. Meanwhile, each of the two sub-modules uses three identical liquid crystal based micro-display chips to generate the three primary color images in the RGB color space separately.

In the illumination sub-system outlined by 412, the light from source 410, which often is in red color, is coupled into a light homogenization device 411 either through direct coupling (as shown in FIG. 4a) or by a condensing optical lens (not shown). The output end of the device 411 is made with an aspect ratio similar to that of the micro-display image chip 418, and is imaged onto (in conjugation with) the chip 418 by the condensing optical lens 413 through the optical components 414, 415 416 and 417. The polarization beam splitter 414, either in the form of a cube as shown in FIG. 4 or in the form of a plate (not shown), reflects the input light beam with predominantly s-polarization (or out-of-plane polarization as shown) toward a linear polarizer 416, through optical compensation module 415.

In the sub engine outlined by 432, the compensation module 415, with an optical thickness that is the same as that of the beam splitter 414 for the transmitted p-polarization, is used to ensure an equal optical path for the two sub-engines. Instead of a compensation component, a pure air space with equivalent optical distance can also be implemented. Note that the absorption type linear polarizer 416, with its polarization axis aligned with the s-polarization direction of the beam splitter 414 or out of paper plane as shown in FIG. 4a, is used to further remove the light in other polarization directions. Thus the further cleaned light beam, with a pure s-polarization, is then reflected by a second polarization beam splitter cube 417 onto the micro-display chip 418. The reflective LCOS chip 418, behaving as an active phase modulator, can rotate the polarization state of some of the pixels and return light in the orthogonal (p) polarization direction (in the paper plane of FIG. 4a). Therefore, those pixelated sub-light beams that are now p-polarized will then be transmitted through the polarization splitter cube 417 and reach the optical beam combiner 429. The remaining portion of those pixelated sub-light beams, which is reflected from chip 418 without polarization rotation, is s-polarized and hence is reflected by cube 417. Afterwards, they will pass through the polarizer 416; get returned to the light homogenization device 411 and light source 410 through optics 415, 414 and 413. Meanwhile, any p-polarization component that can be caused by the imperfectness of the polarization beam splitter 417 will be absorbed by polarizer 416. If the p-polarization component is not absorbed, it could reach another optical channel through beam splitter 414 and cause undesired optical artifact in the displayed stereo images.

Also in the illumination sub-system outlined by 412, the polarization beam splitter 414 allows transmission of the linearly polarized light beam with p-polarization (in plane of paper on FIG. 4a) from the light source 410, which is about half of the output light power from the source 410. In the sub-engine outlined by 422, an optical quarter wave plate 420 with its axes orientated at 45 degree from the p-polarization direction converts the light into circular polarization. The light beam reflected from the mirror 421 exhibits circular polarization in opposite rotation direction, and becomes linearly polarized after passing through wave plate 420 a second time, but in orthogonal polarization direction (s polarization). The light beam is then reflected by the polarization beam splitter 414.

In the sub engine outlined by 422, the s-polarized light beam, after passing through linear polarizer 423, is reflected by the polarization beam splitter cube 425 to reach the micro-display chip 426. There afterwards, the light beam will behave in a similar fashion as has been discussed for the sub-engine 432. Similarly, the function of optical components 423, 425, 426 and 449 is identical to that of 416, 417,418 and 429. It is understood that the output end of the device 411 is also imaged onto (in conjugation with) the chip 426 by the condensing optical lens 413 through the optical components 414, 420, 421, 423, and 425, due to the equal optical path in tow sub engines.

Note that the light beams reaching micro-display chips 418 and 426 come from the same light source 410, and have the same polarization direction and roughly the same light intensity. However, due to the polarization modulation by the LCOS chips 418 and 426, different images will be displayed for the left and right channels. The reflected light beams from the two LCOS chips, when reach the optical beam combiner 429 and 449, represent the intensity modulated red color component of full color images for the left eye and the right eye respectively. It is understood that the optical components described above are designed to work in correspondence with the narrow spectral bandwidth of the light source 410 in terms of optical properties and optical coatings on these components.

Similarly, the two blue color channels of the stereoscopic projection engine have the same optical layout as for the two red channels and are implemented in a symmetrical configuration on the right side of FIG. 4a. The light from the solid state light source 430, often with a relatively narrow spectrum in blue color, is used to illuminate two identical micro-display chips 438 and 446. All of the optical components, 431, 433, 434, 435, 436, 437, 440, 441, 443, and 445 are designed to work in the corresponding spectral range of the light source 430. FIG. 4b shows the optical layout for the two green color channels, which is identical to that of the other two primary colors, with the difference that this layout is positioned normal to that for the other two primary colors; that is, FIG. 4c shows side view normal to FIG. 4a. All of the optical components, 451, 453, 454, 455, 456, 457, 460, 461, 463 and 465 are also designed to work in the corresponding narrow spectral range of the green light source 450. The green color is combined with the red and blue colors at the two combiners 429 and 449. When viewed from the top of FIG. 4a and FIG. 4b, as can be seen from FIG. 4c, the optical combiner 429, which is a special spectrally selective X-cube as shown in FIG. 3, functions to combine the three primary colors in s-polarization for one of the two stereo pairs, reflects the light beams from red and blue beam paths, but transmits the light beam from the green beam path. The three primary color images generated by the three micro-display chips 418, 438 and 458 will now form a full color image in a single linear s-polarization after the special X-cube 429 and can be projected to a screen by the optical projection lens 474 with or without any further polarization state change. To accomplish the task of overlapping the three primary color images, the three micro-display chips 418, 438 and 458 must be optically aligned precisely and matched to each other at the pixel-to-pixel level. Similarly a bottom view with respect to FIGS. 4a and 4b can be envisioned but is not repeated here. In this case, a second full color image for the other channel of the stereo pair, which also comprises three primary color images generated from the three micro-display chips 426, 446 and 466, will be combined by the special X-cube 449 and projected onto the same screen through projection lens 477. Note that although we have drawn two projection lenses 474 and 477, these two lenses can be a shared single lens if additional optical modules are used to combine the two light beams either together or physically very close to each other.

The special spectrally selective X-cube 449 and 429 are made with optical properties as has been described in FIG. 3. Accordingly, the three light beams 480, 481, 482 have the same polarization direction, which is normal to the paper plane of FIG. 4c. Similarly, a bottom view (not shown) would show that this polarization statement is also true for other full color image of the stereo pair. Therefore, both light beams of left and right image generated respectively by the two sub-engines have the same polarization direction, which for now is not ready for polarization based simultaneously stereoscopic display yet. Further polarization manipulation is still need to convert the two collinear polarization states into two orthogonal states and will be explained shortly. Note that FIG. 4c also shows spectrum of the three primary color light beams 480, 481, and 482. It is preferred that the three spectral bands are relatively well separated so that there is no spectral overlap but meanwhile each spectral band is also not too narrow to cause optical speckles to appear in the display.

As shown in FIGS. 4b and 4c, two broadband absorption type linear polarizers 470, 475 are used respectively for each of the two stereo channels to clean up the linear polarization and hence get rid of the unwanted polarization components. This is preferred because if the polarization is not pure, cross talk may occur even if the depolarization effect of the screen and projection lenses 474 and 477 are considered non-existent. Nevertheless, in practice, there is a limit to the purity of a polarization state due to, for example, the limited extinction ratio of any polarization manipulation component, the existence of small alignment errors and the depolarization effect in each optical component.

To create two passively distinguishable images for each of the two eyes of the observer, two broadband optical quarter wave plates 471 and 476 are inserted respectively into the two optical paths behind the two purification linear polarizers 470 and 475, as shown in FIG. 4b and FIG. 4c. The orientations of the two quarter wave plates are arranged orthogonally and at 45° with respect to the linear s-polarization direction as shown in FIG. 4d, where the notation “o” stands for the ordinary axis and “e” stands for the extraordinary axis of the quarter wave plate. After passing through the two quarter wave plates 471 and 476, one image light beam will become circularly polarized in clock wise direction while the other will become circularly polarized in counter-clock wise direction, thus forming two passively distinguishable images of orthogonal polarizations on the screen. When a pair of broadband circular analyzer spectacles, which can be constructed using the same polarizer/quarter wave plate combinations as shown in FIG. 4d, but arranged in reverse order, is worn by the observer, the left and right images will be demultiplexed and be seen by individual eyes separately. A benefit of using two orthogonal circular polarizations to distinguish the left and right images is that the cross talk will not be deteriorated by the rotation of the observer's head. However, this preference should not exclude the possibility that two orthogonal linear polarizations can also be used for passively distinguishing the two images. In this latter case, one only need to rotate the polarization direction of one of the two light beams by 90°, using for example a broadband half-wave plate.

It is to be understood that the polarizer/quarter wave plate combinations, 470/471 and 475/476, can be arranged after projection lens 474/477 to achieve same effect as shown in FIG. 4b and FIG. 4c with the benefit that the depolarization effect that may be introduced by the projection lens 474/477 can be further cleaned up.

The brightness of images from two sub engines could be slightly different due to the imperfection of the optical components. However, the difference can be reduced by adjusting the optical aperture of one of the projection lens, inserting a neutral density filter into one light path, or adjusting image brightness electronically through the micro-display chip with its extra dynamic range.

FIG. 4e shows the top view of the optical layout of the three illumination sub-systems utilizing three primary color solid state light sources. One advantage of the design is that the cost of the overall system can be reduced because the optics for each channel are made with same size, but coated with optical films that are best suitable for the spectral band of each individual light source.

One aspect of the present invention is that the stereoscopic projection engine can be used to project images of any aspect ratio although an aspect ratio of 1:1 is used for the micro-display chips and other optical components as shown in the Figures. For example, it can be used to project images in the most commonly used image aspect ratios of 4:3 and 16:9. The image generating micro-display chips could be oriented in either the vertical or horizontal direction if it is not in the shape of a square. In order to reduce the size of the optical components and minimize optical distortion that can be introduced from the projection lens, the display chips 418, 438, 458 are preferably arranged so that the long side of the display chips is visible from the top view, as shown in FIG. 4c.

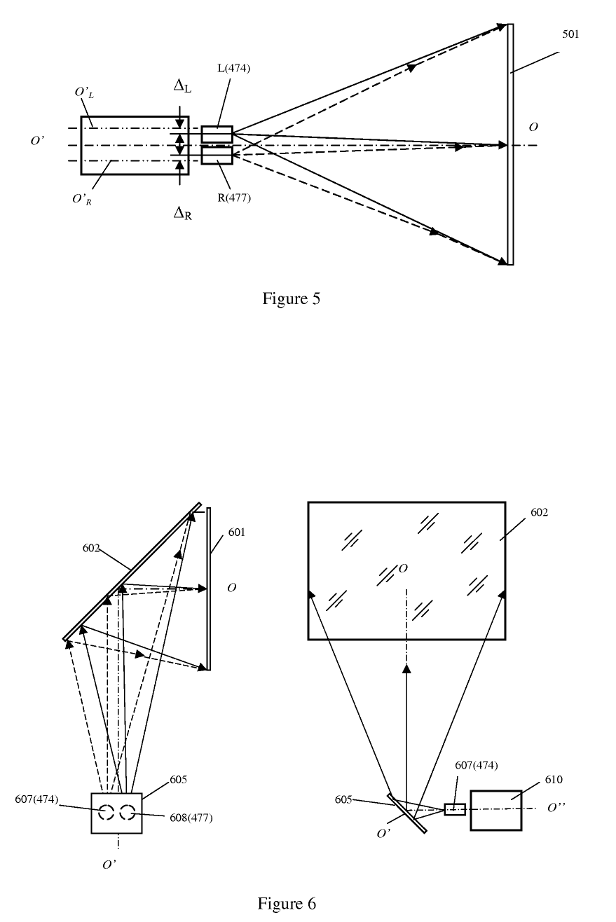

As can be seen in FIG. 4b, the optical axes of the two sub-engines 462, 467 are designed to be exactly parallel. While the projection lenses 474 and 477 can be aligned alone the optical axes of the two stereoscopic imaging paths, the projected images on the screen will be offset by a distance equal to that between the optical axes of two projection lenses 474 and 477. FIG. 5 shows an improvement over the arrangement of the two projection lenses as shown in FIG. 4b, in which a small inward translation toward the central axis of the screen 501 by the projection lens axes, Δ_{L} and Δ_{R}, from the optical axes O′_{L} and O′_{R} of the two imaging paths, can be introduced for the projection lenses 474 and 477, in order to laterally shift and hence superimpose the left and right images from the two sub-engines on the screen 501. The amount of translation Δ_{L} could be, but not necessarily needed to be equal to Δ_{R}.

The presently disclosed projection engine can be used in a front projection display system, as illustrated in FIG. 5. The display screen 501 is specially made so that the reflected (diffused) light from the screen maintains the polarization state of the incoming light with minimum depolarization effect. However, the same engine with proper adjustment for image offset can also be used in a rear projection display system.

As another aspect of the present invention, when the disclosed stereoscopic projection engine is used in a rear projection configuration, a special beam folding arrangement is proposed to compensate the depolarization effect that can be introduced by beam folding mirror(s). FIG. 6 shows such a rear projection system, consisting of a stereoscopic projection engine 610, two projection lenses 607, 608, two reflective mirrors 605, 602 arranged to enable polarization depolarization compensation and a special display screen 601 which is capable maintaining polarization state of passing light with minimum depolarization effect. For the convenience of description, an imaginary optical axis 0-0′ is drawn to represent the base line of the rear projection system. To reduce the depth of the display unit, a large reflective mirror 602, which is preferably coated with metallic and dielectric coatings, is used to bend the light beam by 90 degrees to the screen 601. However, the use of a mirror with even slightly different reflectivity in s and p polarization can cause significant geometric depolarization for the reflected light beams, especially for skew light rays. The depolarization effect will reduce the ANSI contrast of the stereoscopic images and increase the cross-talk between the left and right channels perceived by observers. To minimize the depolarization impact, a second mirror 605 with exactly the same mirror coating as that of the upper larger mirror 602 is introduced between the mirror 602 and projection engine 610. As shown in FIG. 6, the plane of incidence for mirror 605, which is formed by the base line O′-O″ and normal of the mirror 605, is perpendicular to the plane of incidence for mirror 602, which is formed by base line O-O′ and normal of the mirror 602. This arrangement results in two orthogonal right angle turns of the base line from the projection system to the screen, one at the center of the mirror 605 and the other at the center of mirror 602. With such an arrangement, the s-polarization at the turn of the lower mirror 605 will become p-polarized at the turn of the upper mirror 602 and the p-polarization at the turn of the lower mirror 605 will become s-polarized at the turn of the upper mirror 602. Consequently, any depolarization terms from s to p (or p to s) at the first turn will be reversed from p to s (or s to p) at the second turn, resulting in reduction in depolarization effect. Since the projected images are also rotated by 90 degrees at the mirror 605, the projection lenses 607 and 608 can be orientated accordingly to maintain the proper orientation of the final displayed image.

In the optical layout shown in FIG. 6, the reflective surface of mirror 602 is placed at 45 degrees relative to the horizontal direction. Although this arrangement is simple to implement, the configuration also leads to boxy construction with a depth close to half of the screen height. To reduce the depth of the display unit, FIG. 7 shows an alternative of a rear projection system, in which a smaller angle is used for the mirror 702. To maintain the required relationship, in which the plane of incidence for mirror 702 is perpendicular to that for mirror 705 and the angle of incidence is same for tow mirrors, the projection engine 710 and its projection lenses 707, 708 are preferably also rotated in two directions as shown in FIG. 7.

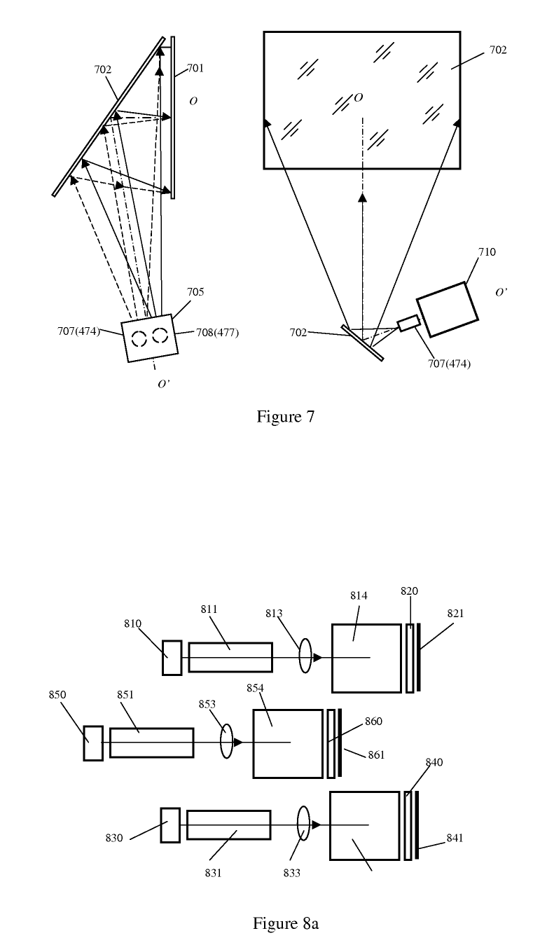

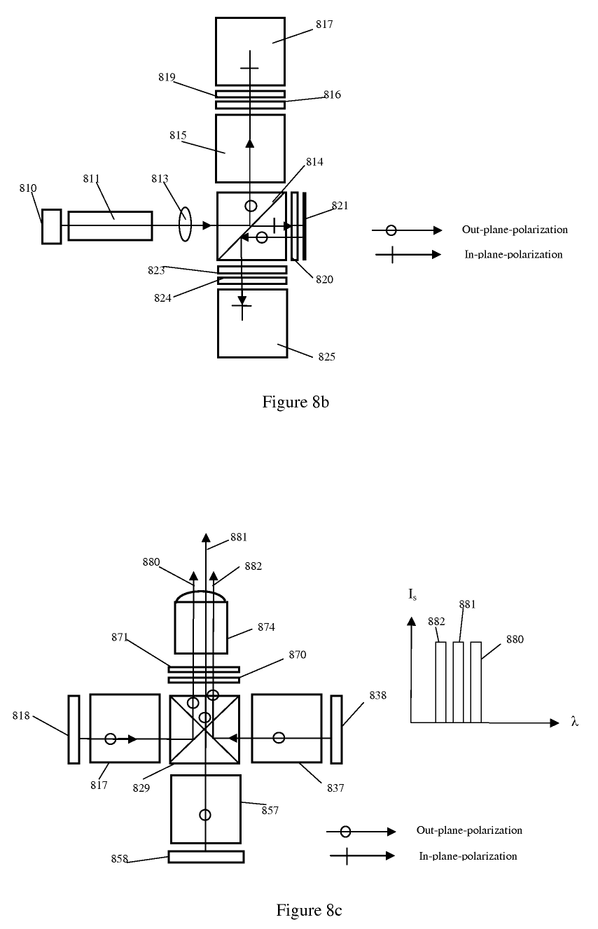

FIGS. 8a and 8b show another embodiment of the projection engine design, in which all of the solid light sources and the light homogenization devices are located on one side of the engine. This design reduces the overall size. In comparison with FIG. 4e, the light source 810, 850, and 830 are equivalent to 410, 450, and 430 respectively. The optical layout and components used for generating the green images are identical as shown in FIG. 4b. However, due to the rotation of the optical path for the red and blue color channels, additional optical components are added to maintain the proper polarization state for the micro-display chips. FIG. 8b exemplifies the optical layout for red color channel, in which two optical half-wave plate 819 and 824 are used to rotate the polarization direction of the red light beam by 90° because the polarization splitter 814 is rotated by 90° compared with the layout shown in FIG. 4a. The optical layout for the blue color channel is identical to that of the red color channel, except that the optical components are made for a different optical spectral band. As shown in FIG. 8c, for the combination of the three primary colors, a similar special spectrally selective X-cube 829 as elaborated before can be used and the arrangement of the three polarization beam splitters 817, 837, 857 are same to that of 417, 437, and 457. The rest of the stereoscopic projection engine is similar to what has already been discussed.

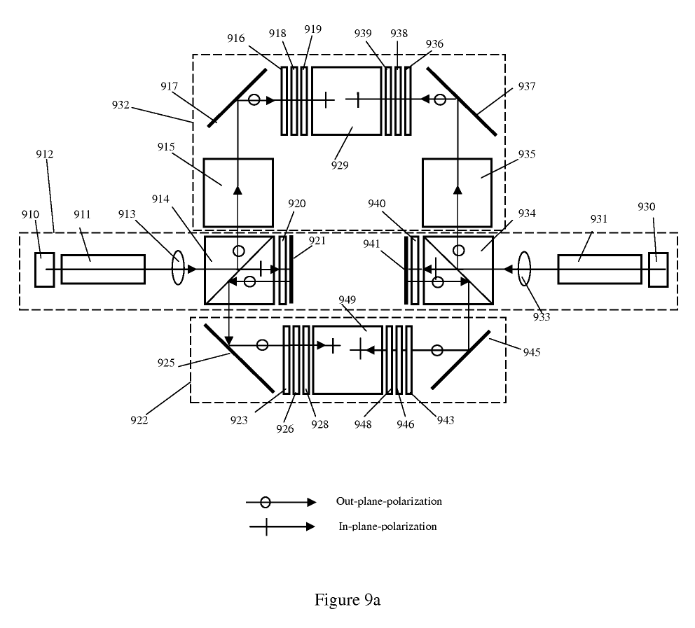

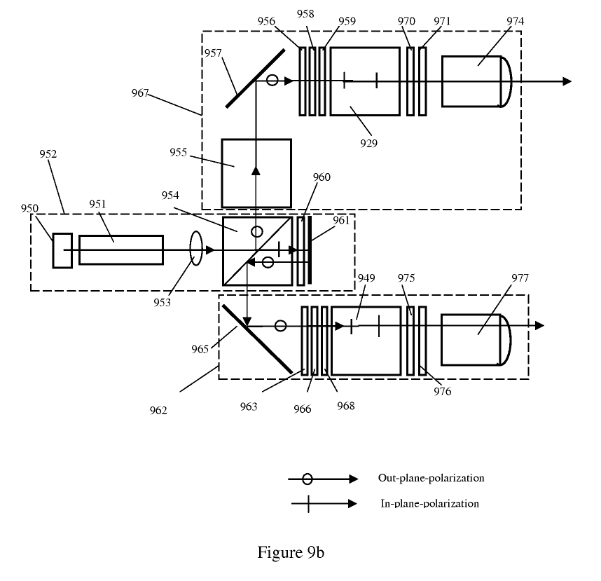

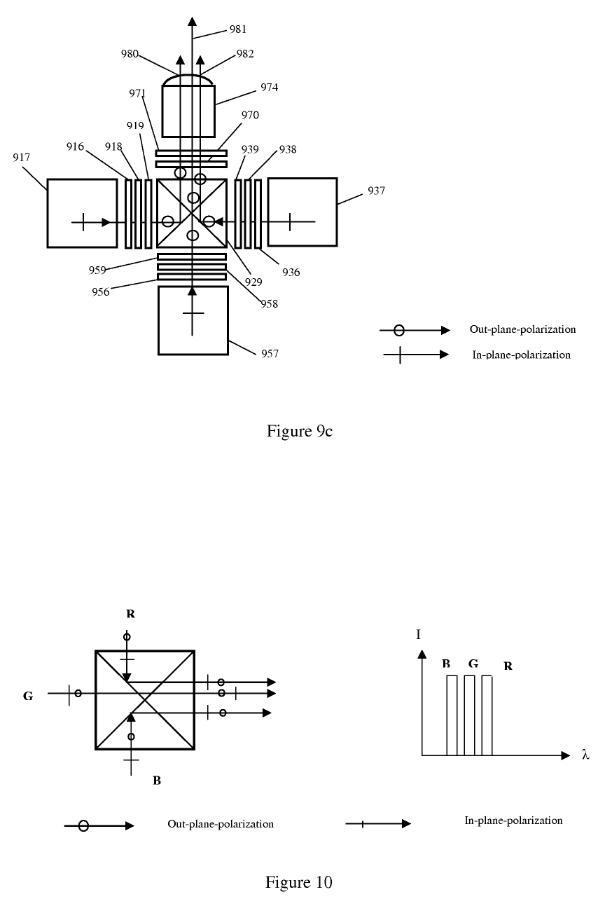

The same technology and design concept can also be applied to a stereoscopic projection engine based on transmissive LCD micro-display technologies. FIG. 9a shows one side view of another embodiment of the stereo display system that has the same optical design for light illumination engine but uses transmissive LCD micro-display chips to achieve the same goal of generating light with same single polarization for the combined full color beam. Two sub-modules 932, 922 generate the same images as 432, 425, while the light or optical energy is provided by the illumination sub-system 912, similar to that of module 412. The light sources 910, 930 and 950 in FIGS. 9a and 9b correspond to the light sources 410, 430 and 450 in FIGS. 4a, 4b and 4e. Instead of a polarization beam splitter cube 417 (425, 437 445), a reflective surface 917 (925, 937, 945) is used to guide the light beam to the transmissive micro display chip 918 (926, 938, 946). Two absorption type linear polarizers 916 and 919 (923 and 928, 936 and 939, 943 and 948), with their polarization axes perpendicular to each other, are placed on the opposite sides of the LCD chip 918 (926, 938, 946). Similar to polarizer 416 (423, 436, 443), the polarizer 916 (923, 936, 943) is used to suppress the stray polarization light in the light beam. FIG. 9b shows the green color channel side section view of the embodiment of FIG. 9a and it is easy to understand when referenced to the similarity and difference of design shown in FIG. 4b. FIG. 9c shows the top view of the embodiment of FIGS. 9a and 9b, illustrating the imaging channels only. Due to the use of transmissive micro-displays, the polarization of the light beam is rotated by the display chip/polarizer combination module by 90° for all of the three color channels. Accordingly, the three primary color light beams 980, 981 and 982, when exiting from the light engine after the special X-cube or optical beam combiner 929, have the same optical polarization direction and form the same full color image as in the case of the light beams 480, 481 and 482

The stereoscopic projection engine, described in FIGS. 9a, 9b and 9c, can be used in either front or rear projection display systems in an identical way as and virtually exchangeable with the one described before.

It should be understood that the embodiment of the illumination sub-system discussed in FIGS. 8a and 8b is also applicable to the projection engine described in FIGS. 9a, 9b and 9c. Additional optical components, like half-wave plates, are placed inside the red and blue channels of the engine similar to elaborated above, in order to maintain the required polarization states.

Besides the special spectrally selective optical beam combiner (X-cube), described in FIG. 3, it should be understood that other spectrally selective X-cubes can also be used. For example, the X-cube can be one that works for the p-polarization instead of s-polarization as shown in FIG. 3. As another alternative, FIG. 10 shows another X-cube design that is also suitable for the presently disclosed stereoscopic projection engines. The embodiment specified in FIG. 3 only transmits green light beam in s-polarization, while reflects red and blue light beams in s-polarization. As shown in FIG. 10, the alternative optical beam combiner is polarization insensitive because it reflects red and blue light in both polarization and transmits green light in both polarization too. In FIG. 10, G, R, B represent green, red and blue light beams respectively.

To implement the X-cube working in p-polarization for the engine elaborated in FIGS. 4a, 4b, 4c, 4d and 4e, the polarization beam splitter 417, 437, 425, 445, 457, and 465 have to be rotated by 90° to allow the p-polarized light beam to pass through. Then a matching reflector for each beam splitter is added to its side to further guide the light beam from the polarizer 416, 436, 423, 443, 456, and 463. The embodiment of the illumination sub-system discussed in FIGS. 8a and 8b is also applicable to the LCOS projection engine using the X-cube described in FIG. 10 for p-polarization. Additional optical components, like half-wave plates, are placed inside the red and blue channels of the engine similar to elaborated above, in order to maintain the required polarization states.

To implement the X-cube working in p-polarization for the engine elaborated in FIGS. 9a, 9b and 9c, a half-wave plate is inserted between beam splitter 914 and polarizer 916 to rotate the polarization direction by 90°. Accordingly the image modulation module, which consists of 916, 918 and 919, is also rotated by 90°. As the result, the polarization for light beam exiting 919 is in p-polarization for the X-cube. Similar modifications are carried out for all of micro-displays in other channels and colors. The embodiment of the illumination sub-system discussed in FIGS. 8a and 8b is also applicable to the transmissive LCD projection engine using the X-cube described in FIG. 10 for p-polarization. Due to the rotation of the beam splitter 914 and 934 by 90°, only one half-wave plates is placed inside the green channel of the engine, between beam splitter 954 and polarizer 956, to rotate the polarization direction by 90°. Accordingly, the image modulation modules for three primary colors, which for example, consist of 916, 918, 919 and 923, 926, 928 for red color, are also rotated by 90° to generated p-polarized light beam in X-cube.

It is also to be understood that, although red, green and blue (RGB) based primary colors are used in the discussion for forming the full color image and architectural design of the projection engine, the embodiments are also suitable for projection engines using the complementary colors of RGB. Hence the term “three primary colors” should be interpreted as represent any three colors that can result in a full color display on a monitor when they are combined.

What is claimed is:

1. A simultaneous polarization based stereoscopic projection engine, comprising three primary color solid state light sources of random polarization, three polarization beam splitters for splitting each primary color light into two orthogonal polarization states, one for the left channel and one for the right channel,
three pairs of polarization based micro-displays for image encoding,
a pair of special spectrally selective beam combiners or X-cubes, one for the left channel and one for the right channel, for combining the simultaneous stereo pair of image encoded three primary colors into a pair of full color image encoded beams of a single polarization state,
a pair of polarization manipulation device for converting the single polarization state of the pair of image encoded beams into two beams of orthogonal polarization states for the left and right stereo channels respectively, and
a pair of projection lenses for projecting the pair of stereoscopic images onto a screen.

2. The stereoscopic projection engine of claim 1, wherein said solid state light source is a light emitting diode (LED).

3. The stereoscopic projection engine of claim 1, wherein said solid light source is a superluminescent light emitting diode (SLED).

4. The stereoscopic projection engine of claim 1, wherein said solid light source is a laser diode (LD).

5. The stereoscopic projection engine of claim 1, further comprising three light homogenization devices each between a primary color solid state light source and its corresponding polarization beam splitter.

6. The stereoscopic projection engine of claim 1, wherein said three primary color solid state light sources are arranged perpendicular to each other.

7. The stereoscopic projection engine of claim 1, wherein said three primary color solid light sources are arranged parallel to each other to further save space.

8. The stereoscopic projection engine of claim 1, wherein said polarization beam splitter is a polarization beam splitter cube.

9. The stereoscopic projection engine of claim 1, wherein said polarization beam splitter is a polarization beam splitter plate.

10. The stereoscopic projection engine of claim 1, further comprising three optical quarter-wave plates and three reflectors respectively behind the three polarization beam splitters for redirecting one of the polarization divided beams sideway so that it is opposite to the propagation direction of another polarization divided beam.

11. The stereoscopic projection engine of claim 1, further comprising three optical path length compensating blocks with an optical equivalent thickness that is the same as that of the beam splitter to ensure an equal optical path for the left and right channels.

12. The stereoscopic projection engine of claim 1, wherein said micro display is a liquid crystal on silicon (LCOS) chip.

13. The stereoscopic projection engine of claim 1, wherein said micro display is a transmissive liquid crystal display chip.

14. The stereoscopic projection engine of claim 1, further comprising three pairs of absorptive linear polarizers respectively between the polarization beam splitters and the micro-displays for purifying the polarization state and also preventing depolarized light component from leaking backward into the other stereoscopic channels.

15. The stereoscopic projection engine of claim 1, further comprising three pairs of polarization selection components associated with each of the three pairs of micro displays for selecting and directing the image encoded sub-light-beams to the corresponding X-cube.

16. The stereoscopic projection engine of claim 15, wherein said polarization selection component is a polarization beam splitter cube.

17. The stereoscopic projection engine of claim 15, wherein said polarization selection component is an absorption type linear polarizer.

18. The stereoscopic projection engine of claim 1, wherein said spectrally selective beam combiner or X-cube is one that reflects two primary color beams from two opposite sides of the X plane in s-polarization and transmits the third primary color beam from the third side of the X-plane in s-polarization.

19. The stereoscopic projection engine of claim 1, wherein said spectrally selective beam combiner or X-cube is one that reflects two primary color beams from two opposite sides of the X plane in p-polarization and transmits the third primary color beam from the third side of the X-plane in p-polarization

20. The stereoscopic projection engine of claim 1, wherein said spectrally selective beam combiner or X-cube is one that reflects two primary color beams from two opposite sides of the X plane in both s- and p-polarization and transmits the third primary color beam from the third side of the X-plane in both s- and p-polarization.

21. The stereoscopic projection engine of claim 1, wherein said pair of polarization manipulation devices comprises a pair of polarization purification linear polarizers and a pair of optical broadband quarter-wave plates.

22. The stereoscopic projection engine of claim 1, wherein said pair of polarization manipulation devices comprises a pair of polarization purification linear polarizers and an optical broadband half-wave plate for rotating the linear polarization direction of only one of two stereoscopic channels by 90 degree.

23. The stereoscopic projection engine of claim 1, wherein said pair of projection lenses are arranged with a certain lateral off set with respect to the two corresponding optical axes of the left and right stereo light channels for overlapping the left and right image on the screen with minimum image distortion.

24. The stereoscopic projection engine of claim 1, wherein said pair of projection lenses is a single lens shared by the two stereoscopic channels.

25. The stereoscopic projection engine of claim 1, wherein said the pair of images displayed are not stereoscopically correlated.

26. A method for projecting a simultaneous pair of full color stereoscopic images, comprising the steps of
using three polarization beam splitters to respectively divide randomly polarized light from three solid state light sources of three primary colors into two orthogonal polarization beams, one of the left channel and one for the right channel,
directing each pair of the divided single polarization beams of the three primary colors respectively into three pairs of polarization based micro display for encoding the left and right images for the three primary colors,
combining the image encoded beams of the three primary colors of the left and right channels into a pair of full color image encoded beams of a single polarization state using a pair of spectrally selective beam combiners or X-cubes,
converting the pair of full color image encoded beams of a single polarization state into two orthogonal polarization states and
projecting the pair of image encoded beams of orthogonal polarization states onto a projection screen.

27. A simultaneous polarization based stereoscopic projection engine, comprising
two projection engines utilizing solid state light sources of three primary colors,
one projects for the left channel and one project for the right channel,
combining the image encoded beams of the three primary colors of the left and right channels into a pair of full color image encoded beams of a single polarization state using a pair of spectrally selective beam combiners or X-cubes,
converting the pair of full color image encoded beams of a single polarization state into two orthogonal polarization states and
projecting the pair of image encoded beams of orthogonal polarization states onto a projection screen.
